(19) United States
(12) Patent Application Publication
(10) Pub. No.: US 2006/0132647 A1
(43) Pub. Date: Jun. 22, 2006

(54) METHOD AND APPARATUS FOR SIMULTANEOUS DISPLAY IN PROGRESSIVE AND INTERLACED SCANNING MODES

(76) Inventors: Ming-Jane Hsieh, Taipei City (TW); Yueh-Hsing Huang, Tai-Chung Hsien (TW); Te-Ming Kuo, Hsin-Chu Hsien (TW); Zou-Ping Chen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/164,139

(22) Filed: Nov. 11, 2005

(30) Foreign Application Priority Data
Dec. 22, 2004 (TW) 093140100

(51) Int. Cl. H04N 7/01

(52) U.S. Cl. 348/446

(57) ABSTRACT

A video data processing device for displaying an interlaced field in a displaying device according to a progressive frame, the video data processing device includes a video input/output interface for receiving the progressive frame; a buffer device coupled to the video input/output interface for storing a plurality of pixel data of the progressive frame; and a processing module coupled to the buffer device for outputting the pixel data to the buffer device. The buffer device outputs the pixel data for driving the displaying device to show the interlaced field.

### BACKGROUND OF THE INVENTION

1. Field of the Invention

The invention relates to a method and a device for displaying video data, and more particularly, to a method and a device for simultaneous display in progressive and interlaced scanning modes.

2. Description of the Prior Art

As known by those skilled in the art, a regular digital TV supports several analog display interfaces (for example, S-video terminals, composite terminals, and component terminals). Among the aforementioned types of terminals, however, some display interfaces support the progressive scanning mode, whereas the others support solely the interlaced scanning mode. Due to the fact that progressive scanning and interlaced scanning are different video driving mechanisms, a display interface that supports interlaced scanning alone would have trouble in displaying an image when only signals of progressive scanning are to be received.

### SUMMARY OF THE INVENTION

It is therefore one of the primary objectives of the claimed invention to provide a method and a device for simultaneous display in interlaced and progressive scanning modes, to solve the above-mentioned problem.

According to an exemplary embodiment of the claimed invention, a video-processing device for outputting a field of interlaced scanning according to a frame of progressive scanning is disclosed. The video processing device comprises an input/output interface for receiving the progressive scanning frame and a control module coupled to the input/output interface for receiving a plurality of frame pixel data of the frame and outputting a corresponding plurality of field pixel data, wherein the control module receives the frame pixel data according to a first clock corresponding to progressive scanning and outputs the field pixel data according to a second clock corresponding to interlaced scanning.

Furthermore, another video processing device for outputting a field of interlaced scanning according to a frame of progressive scanning is disclosed. The video-processing device comprises an input/output interface for receiving the frame and a buffering device coupled to the input/output interface for receiving and temporarily storing the frame. The buffering device outputs a corresponding plurality of field pixel data, wherein the buffering device receives the frame according to a first clock corresponding to progressive scanning and outputs the field pixel data according to a second clock corresponding to interlaced scanning.

In addition, a video processing method for outputting a field of interlaced scanning to a first displaying device according to a frame of progressive scanning is disclosed. The video processing method comprises: receiving the frame; storing a plurality of frame pixel data of the frame according to a first clock corresponding to progressive scanning; and outputting a plurality of field pixel data to the first displaying device according to a second clock corresponding to interlaced scanning in order to display the field.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a first embodiment of a video-processing device according to the present invention.

FIG. 2 is an operational flow chart of the video processing device shown in FIG. 1.

FIG. 3 is a diagram of a second embodiment of a video-processing device according to the present invention.

FIG. 4 is an operational flow chart of the video processing device shown in FIG. 3.

### DETAILED DESCRIPTION

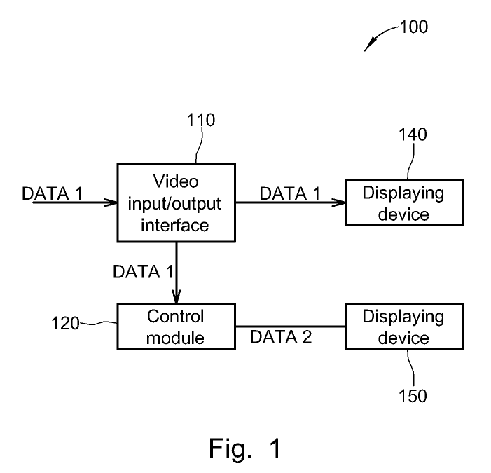

In the following disclosure, the present invention can be utilized in both NTSC and PAL video systems. Please refer to FIG. 1, which is a diagram of a first embodiment of a video-processing device 100 according to the present invention. As shown in FIG. 1, the video processing device 100 comprises a video input/output interface 110 for receiving frames of progressive scanning or fields of interlaced scanning, and a control module 120 coupled to the video input/output interface 110 for outputting a plurality of pixel data of the frames of progressive scanning corresponding to the fields of interlaced scanning. The method of de-interlacing the fields of interlaced scanning in order to display progressive frames is well known, and thus omitted.

Furthermore, a displaying device 140 is coupled to the video input/output interface 110 for displaying images of progressive scanning, and another displaying device 150 is coupled to the control module 120 for receiving pixel data outputted by the control module 120 and displaying images of interlaced scanning. The video-processing device 100 can be installed in a set top box or other multimedia players.

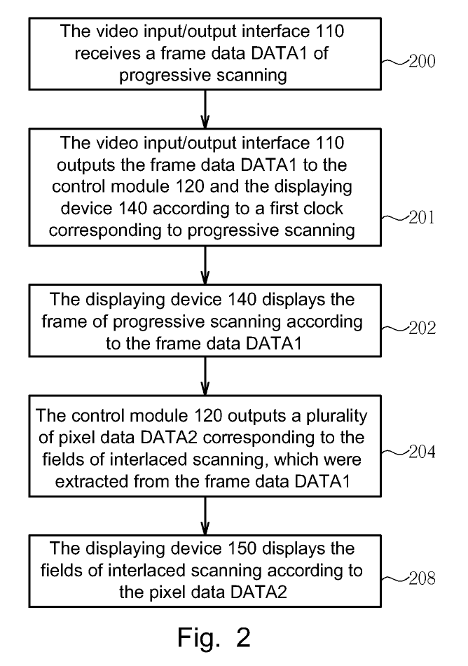

Please refer to FIG. 2 in conjunction with FIG. 1. FIG. 2 is an operational flow chart of the video-processing device 100 shown in FIG. 1. The flow chart comprises the following steps.

Step 200: The video input/output interface 110 receives a frame data DATA1 of progressive scanning;

Step 201: The video input/output interface 110 outputs the frame data DATA1 to the control module 120 and the displaying device 140 according to a first clock corresponding to progressive scanning;

Step 202: The displaying device 140 displays the frame of progressive scanning according to the frame data DATA1;

Step 204: The control module 120 outputs a plurality of pixel data DATA2 corresponding to the fields of interlaced scanning, which were extracted from the frame data DATA1; and

Step 208: The displaying device 150 displays the fields of interlaced scanning according to the pixel data DATA2.

In the above steps, the control module 120 outputs pixel data DATA2 corresponding to the fields of interlaced scanning, pixel data which do not correspond to the fields of interlaced scanning are either not outputted or not received. For example, since only one of two successive scan lines of a frame would correspond to the fields of interlaced scanning, during the time the video input/output interface 110 outputs pixel data of two successive scan lines, the control module 120 will either receive pixel data from one of the scan lines or receive pixel data from both. In the latter case, the output to the displaying device 150 would be the pixel data of only one of the scan lines.

The above-mentioned control module 120 can further comprise an asynchronous buffer (not shown) for storing the pixel data DATA2. In this case, when the control module 120 receives pixel data of the first scan line of the frame data DATA1, the control module 120 stores the pixel data of the first scan line to the asynchronous buffer according to a first clock corresponding to the progressive scanning mode, and the asynchronous buffer outputs the pixel data to the displaying device 150 according to a second clock corresponding to the interlaced scanning mode. Then, the control module 120 stops storing pixel data of the second scan line to the asynchronous buffer. However, the asynchronous buffer continues to output the pixel data of the first line to the displaying device 150 according to the second clock. Therefore, the fields of interlaced scanning are displayed on the displaying device 150. In addition, if the displaying device 150 is an analog displaying device, a digital-to-analog converter (not shown) has to be installed in the end terminal of the asynchronous buffer to transform output digital signals into analog ones.

In the above-mentioned embodiment, the frequency of the first clock is generally twice the frequency of the second clock. Memory space of the asynchronous buffer could thus be reduced to a capacity of storing only half a scan line. Please note that the half-scan-line memory storage space is only utilized as a preferred embodiment, not a limitation. For example, while the control module 120 stores pixel data of the front half of the scan line to a line buffer, the line buffer also outputs pixel data of the front quarter of the stored scan line to the displaying device 150. When the control module 120 starts storing the succeeding half of the scan line to the line buffer, the line buffer outputs the pixel of the remaining stored scan line. Once the pixel data of the succeeding half of the scan line are stored in the line buffer, the line buffer would have finished outputting all the pixel data of the front half of the scan line to the displaying device 150. At this time, the control module 120 prevents storage of the pixel data of the second scan line to the line buffer, and the line buffer goes on outputting the remaining pixel data of the succeeding half of the scan line to the displaying device 150.

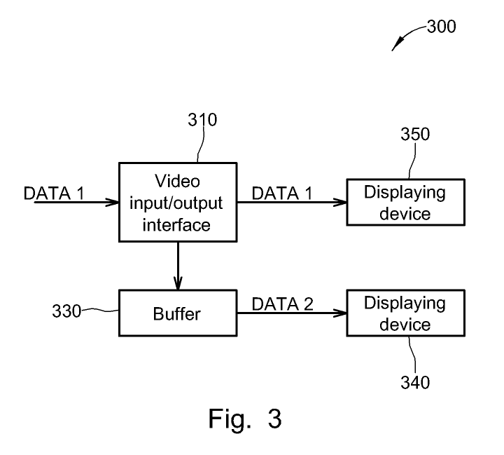

Please refer to FIG. 3, which is a diagram of a second embodiment of a video-processing device 300 according to the present invention. The video processing device 300 comprises a video input/output interface 310 for receiving frames of progressive scanning or fields of interlaced scanning, and a buffer 330 (for example, a line buffer) coupled to the video input/output interface 310 for temporarily storing the frames and outputting a plurality of pixel data corresponding to the fields of interlaced scanning. As before, the method of de-interlacing the fields of interlaced scanning to display progressive frames is well known, and thus omitted. In this embodiment, one displaying device 340 is coupled to the buffer 330 for displaying images of interlaced scanning, and another displaying device 350 is coupled to the video input/output interface 310 for displaying images of progressive scanning. The video-processing device 300 can be installed in a set top box or other multimedia players.

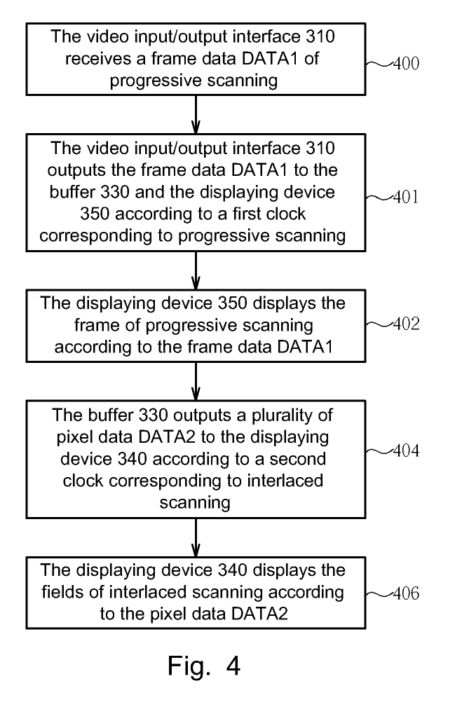

Please refer to FIG. 4 in conjunction with FIG. 3. FIG. 4 is an operational flow chart of the video-processing device 300 shown in FIG. 3. The flow chart comprises the following steps:

Step 400: The video input/output interface 310 receives a frame data DATA1 of progressive scanning;

Step 401: The video input/output interface 310 outputs the frame data DATA1 to the buffer 330 and the displaying device 350 according to a first clock corresponding to progressive scanning;

Step 402: The displaying device 350 displays the frame of progressive scanning according to the frame data DATA1;

Step 404: The buffer 330 outputs a plurality of pixel data DATA2 to the displaying device 340 according to a second clock corresponding to interlaced scanning; and

Step 406: The displaying device 340 displays the fields of interlaced scanning according to the pixel data DATA2.

In this embodiment, the memory space of the buffer 330 could be reduced to a capacity of storing a single scan line. The reasoning is as follows. When the pixel data of the first and the second scan lines are subsequently outputted to the buffer 330, the buffer 330 outputs pixel data of the first scan line retaining the pixel data of the second scan line, this is due to the fact that the frequency of the first clock is twice the frequency of the second clock. The video input/output interface 310 then outputs the pixel data of the third scan line, overwriting the pixel data of the second scan line stored in the buffer 330. Therefore, the buffer 330 outputs the pixel data of the third scan line to the displaying device 340, skipping the second scan line. Accordingly, the present invention video processing device 300 can simultaneously support interlaced and progressive scanning.

In addition, in order to ensure that the buffer 330 does not output the pixel data of unwanted even/odd scan lines, a control module (not shown) can be utilized to clear all pixel data stored in the buffer 330 at regular intervals. For example, when the pixel data of the first and the second scan lines are orderly outputted into the buffer 330, the above-mentioned control module can clear the pixel data of the second scan line. Please note that the control module can clear the pixel data in the buffer 330 through updating pointers. This process is well known by those skilled in the art, and thus omitted here, too.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A video processing device for outputting a field of interlaced scanning according to a frame of progressive scanning, the video processing device comprising:
an input/output interface for receiving the frame; and
a control module coupled to the input/output interface for receiving a plurality of frame pixel data of the frame and outputting a corresponding plurality of field pixel data;
wherein the control module receives the frame pixel data according to a first clock corresponding to progressive scanning and outputs the field pixel data according to a second clock corresponding to interlaced scanning.

2. The video processing device of claim 1, wherein the control module further comprises a storage unit, the control module stores the field pixel data of the frame pixel data according to the first clock in the storage unit, and the storage unit outputs the field pixel data according to the second clock.

3. The video processing device of claim 2, wherein the storage unit is an asynchronous buffer.

4. The video processing device of claim 2, wherein the storage unit is a line buffer.

5. The video processing device of claim 4, wherein a storage space of the line buffer is equal to or less than needed storage space of a scan line.

6. The video processing device of claim 1, wherein the frame pixel data are equal to the field pixel data.

7. The video processing device of claim 1, wherein the input/output interface outputs the frame pixel data to a first displaying device to display the frame, and the control module outputs the field pixel data to a second displaying device to display the field.

8. A video processing device for outputting a field of interlaced scanning according to a frame of progressive scanning, the video processing device comprising:
an input/output interface for receiving the frame; and
a buffering device coupled to the input/output interface for receiving and temporarily storing the frame, the buffering device outputs a corresponding plurality of field pixel data;
wherein the buffering device receives the frame according to a first clock corresponding to progressive scanning and outputs the field pixel data according to a second clock corresponding to interlaced scanning.

9. The video processing device of claim 8 further comprising:
a control module coupled to the buffering device for clearing data stored in the buffering device according to a predetermined time interval.

10. The video processing device of claim 8, wherein the buffering device is an asynchronous buffer.

11. The video processing device of claim 8, wherein the buffering device is a line buffer.

12. The video processing device of claim 8, wherein the buffering device receives all pixel data of the frame.

13. A video processing method for outputting a field of interlaced scanning to a first displaying device according to a frame of progressive scanning, the video processing method comprising:
receiving the frame;
storing a plurality of frame pixel data of the frame according to a first clock corresponding to progressive scanning; and
outputting a plurality of field pixel data to the first displaying device according to a second clock corresponding to interlaced scanning in order to display the field.

14. The video processing method of claim 13, wherein the frame pixel data are stored in a line buffer.

15. The video processing method of claim 13, wherein the process of storing the frame pixel data is by storing in an amount that is equal to or less than that of a scan line.

16. The video processing method of claim 13, wherein the frame pixel data are not equal to the field pixel data.

17. The video processing method of claim 16 further comprising:
clearing the frame pixel data which do not correspond to the field pixel data according to a predetermined time interval.

18. The video processing method of claim 13, wherein the frame pixel data are equal to the field pixel data.

19. The video processing method of claim 18, wherein the process of storing the frame pixel data further comprises:
halting storage of the frame pixel data if the data to be stored do not correspond to the field.

20. The video processing method of claim 13 further comprising:
outputting the frame to a second displaying device to display the frame.
